(19) United States
(12) Patent Application Publication
(10) Pub. No.: US 2013/0082559 A1
(43) Pub. Date: Apr. 4, 2013

(54) PERMANENT MAGNET AND MOTOR AND GENERATOR USING THE SAME

(71) Applicants: Masaya Hagiwara, Yokohama-shi (JP); Shinya SAKURADA, Tokyo (JP); Yosuke HORIUCHI, Tokyo (JP); Tsuyoshi KOBAYASHI, Kawasaki-shi (JP); Keiko OKAMOTO, Kawasaki-shi (JP)

(72) Inventors: Masaya Hagiwara, Yokohama-shi (JP); Shinya SAKURADA, Tokyo (JP); Yosuke HORIUCHI, Tokyo (JP); Tsuyoshi KOBAYASHI, Kawasaki-shi (JP); Keiko OKAMOTO, Kawasaki-shi (JP)

(73) Assignee: Kabushiki Kaisha Toshiba, Tokyo (JP)

(21) Appl. No.: 13/423,572

(22) Filed: Mar. 19, 2012

(30) Foreign Application Priority Data
Sep. 29, 2011 (JP) P2011-214039

(51) Int. Cl. H02K 21/00; H01F 7/02

(52) U.S. Cl. 310/152; 335/302

(57) ABSTRACT

In one embodiment, a permanent magnet includes a composition represented by R(FeₚM_{q}Cuᵣ(Co_{1-p-q-r})_{z}, (R: rare earth element, M: at least one element selected from Ti, Zr and Hf, 0.3<p≦0.45, 0.01≦q≦0.05, 0.01≦r≦0.1, 5.6≦z≦9), and a metallic structure including a Th₂Zn₁₇ crystal phase, a grain boundary phase and a platelet phase. A spatial distribution of Cu concentration in the grain boundary phase is set to 5 or less in standard deviation.

### CROSS-REFERENCE TO RELATED APPLICATION

This application is based upon and claims the benefit of priority from Japanese Patent Application No. 2011-214039, filed on Sep. 29, 2011; the entire contents of which are incorporated herein by reference.

### FIELD

Embodiments described herein relate generally to a permanent magnet and a motor and a generator using the same.

### BACKGROUND

As a high-performance permanent magnet, rare earth magnets such as Sm—Co based magnets and Nd—Fe—B based magnets are known. When permanent magnets are used in motors for hybrid vehicles (HEV) and electric vehicles (EV), heat resistance of the permanent magnet is demanded. In motors for HEV and EV, there are used permanent magnets whose heat resistance is increased by replacing a part of Nd in the Nd—Fe—B based magnet with Dy. Since Dy is one of rare elements, permanent magnets not using Dy are desired. The Sm—Co based magnets are known for that they exhibit excellent heat resistance without using Dy, but they have a disadvantageous point that (BH)ₘₐₓ is smaller than that of the Nd—Fe—B based magnets.

As factors for determining a value of (BH)ₘₐₓ of the permanent magnet, there can be cited a squareness of hysteresis loop, in addition to residual magnetization and coercive force. Even if a magnet has large residual magnetization, when the squareness is poor, the value of (BH)ₘₐₓ becomes smaller than a theoretical value expected from a magnitude of the residual magnetization. In order to realize a high value of (BH)ₘₐₓ, a good squareness is demanded, in addition to a large magnetization. In order to increase magnetization of the Sm—Co based magnets, it is effective to replace a part of Co with Fe and to increase an Fe concentration. However, in a composition region having a high Fe concentration, the squareness of the Sm—Co based magnets tends to deteriorate. Accordingly, a technique of improving squareness while keeping high magnetization and coercive force in the Sm—Co based magnets with high Fe concentration, is demanded.

### BRIEF DESCRIPTION OF THE DRAWINGS

FIG. 1 is a TEM image illustrating a metallic structure of a permanent magnet according to an embodiment.

FIG. 2 is a diagram illustrating an example of a magnetization curve of the permanent magnet according to the embodiment.

FIG. 3 is a diagram illustrating a permanent magnet motor of the embodiment.

FIG. 4 is a diagram illustrating a variable magnetic flux motor of the embodiment.

FIG. 5 is a diagram illustrating a generator of the embodiment.

### DETAILED DESCRIPTION

According to one embodiment, there is provided a permanent magnet having a composition represented by a composition formula:

R(FeₚM_{q}Cuᵣ(Co_{1-p-q-r})_{z} (1)

where, R is at least one element selected from rare earth elements, M is at least one element selected from Ti, Zr and Hf, p is a number satisfying 0.3<p≦5.0.45 (atomic ratio), q is a number satisfying 0.01≦q≦0.05 (atomic ratio), r is a number satisfying 0.01≦r≦0.1 (atomic ratio), and z is a number satisfying 5.6≦z≦9 (atomic ratio). The permanent magnet includes a metallic structure including a Th₂Zn₁₇ crystal phase, a grain boundary phase and a platelet phase. A spatial distribution of Cu concentration in the grain boundary phase is 5 or less in standard deviation.

Hereinafter, the permanent magnet of the embodiment will be described in detail. In the composition formula (1), at least one element selected from rare earth elements including yttrium (Y) is used as the element R. The element R brings about large magnetic anisotropy in a magnetic material, and gives high coercive force. As the element R, at least one element selected from samarium (Sm), cerium (Ce), neodymium (Nd) and praseodymium (Pr) is preferably used, and it is particularly desirable to use Sm. When 50 atomic % or more of the element R is Sm, it is possible to enhance the coercive force of the permanent magnet with good repeatability. It is desirable that 70 atomic % or more of the element R is Sm.

The element R is compounded so that an atomic ratio of the element R and the other elements (Fe, M, Cu, Co) is in a range of 1:5.6 to 1:9 (range of 5.6 to 9 as the value z/a range of 10 to 15 atomic % as the content of the element R). If the content of the element R is less than 10 atomic %, a large amount of α-Fe phase precipitates and sufficient coercive force cannot be obtained. On the other hand, the content of the element R exceeding 15 atomic % brings about a notable reduction in saturation magnetization. The content of the element R is more preferably set to fall within a range of 10.2 to 14 atomic %, and is further preferably set to fall within a range of 10.5 to 12.5 atomic %.

As the element M, at least one element selected from titanium (Ti), zirconium (Zr) and hafnium (Hf) is used. By compounding the element M, it is possible to realize exertion of large coercive force in a composition with high Fe concentration. The content of the element M is in a range of 1 to 5 atomic % (0.01≦q≦0.05) of a total amount of the elements (Fe, Co, Cu, M) other than the element R. If the value q exceeds 0.05, magnetization decreases significantly. If the value q is less than 0.01, effect of increasing the Fe concentration is small. The content of the element M is more preferably represented by 0.012≦q≦0.04, and is further preferably represented by 0.015≦q≦0.03.

The element M may be any one of Ti, Zr, and Hf, but preferably contains at least Zr. In particular, by having the element M with 50 atomic % or more of Zr, effect of increasing coercive force of the permanent magnet can be further improved. Since Hf in element M is particularly expensive, even in a case of using Hf, it is preferred that the amount of using Hf be small. It is preferable that the content of Hf is set to less than 20 atomic % of the element M.

Copper (Cu) is an element for allowing the permanent magnet to exert high coercive force. The content of Cu is in a range of 1 to 10 atomic % (0.01≦r≦0.1) of the total amount of the elements (Fe, Co, Cu, M) other than the element R. If the value r exceeds 0.1, magnetization decreases significantly. If the value r is less than 0.01, it becomes difficult to obtain high coercive force. The content of Cu is more preferably represented by 0.02≦r≦0.1, and is further preferably represented by 0.03≦r≦0.08.

Iron (Fe) mainly bears magnetization of the permanent magnet. It is possible to enhance the saturation magnetization of the permanent magnet when a large amount of Fe is compounded. When the content of Fe becomes excessive, coercive force decreases due to precipitation of α-Fe phase. The content of Fe is in a range of more than 30 atomic % and equal to or less than 45 atomic % (0.3<p≦0.45) of the total amount of the elements (Fe, Co, Cu, M) other than the element R. The content of Fe is more preferably represented by 0.31≦p≦0.44, and is further preferably represented by 0.32≦p≦0.43.

Cobalt (Co) is an element responsible for magnetization of the permanent magnet and necessary for allowing the magnet to exert high coercive force. Further, when a large amount of Co is contained, Curie temperature becomes high, and thermal stability of the permanent magnet is also improved. When the content of Co is small, these effects become small. When Co is excessively contained in the permanent magnet, the content of Fe decreases relatively, which may cause decrease in magnetization. The content of Co is set to fall within a range of (1-p-q-r) defined by p, q, r as described above.

A part of Co may be replaced with at least one element A selected from nickel (Ni), vanadium (V), chrome (Cr), manganese (Mn), aluminum (Al), silicon (Si), gallium (Ga), niobium (Nb), tantalum (Ta), and tungsten (W). These replacement elements contribute to improvement of magnetic characteristics, for example, coercive force. Excessive replacement of Co with the element A may cause decrease in magnetization. The amount of replacement by the element A is preferably set to fall within a range of 20 atomic % or less of Co. Note that the magnetic material of the embodiment allows containing inevitable impurities such as oxide.

The Sm—Co based magnet of this embodiment includes a phase separation structure formed by performing aging treatment on a TbCu₇ crystal phase (crystal phase having a TbCu₇ type structure/1-7 phase) being a high-temperature phase which is used as a precursor. The phase-separated metallic structure has a Th₂Zn₁₇ crystal phase (phase having a Th₂Zn₁₇ type structure/2-17 phase) as a main phase, a grain boundary phase formed of a CaCu₅ crystal phase (crystal phase having a CaCu₅ type structure/1-5 phase) and a platelet phase. The phase-separated metallic structure takes a secondary structure called a cell structure.

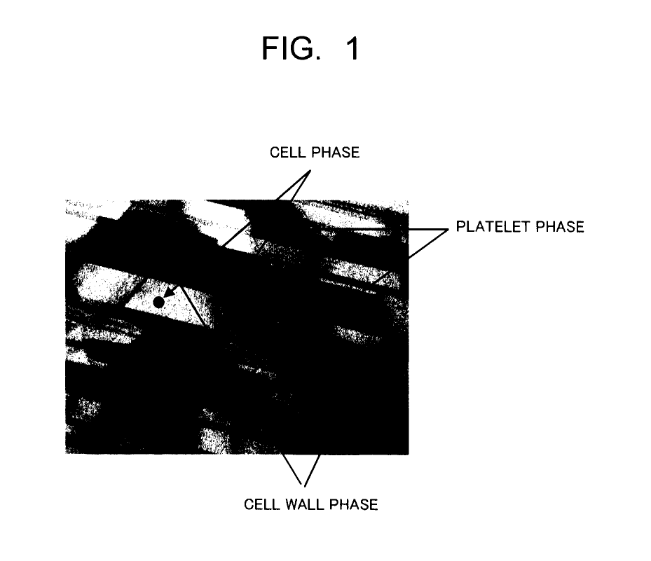

The phase-separated metallic structure is observed by a TEM image (transmission electron microscope image) seen from a direction parallel to an easy magnetization axis (c-axis direction of crystal) of a sample after being subjected to the aging treatment. FIG. 1 is an example of TEM image of the Sm—Co based magnet of the embodiment. As illustrated in FIG. 1, a structure mainly observed in the TEM image after performing the aging treatment includes the 1-7 phase (cell phase) being the main phase, the 1-5 phase (cell wall phase) being the grain boundary phase and the platelet phase. The cell phase is a crystal grain whose grain diameter is about 50 to 200 nm. The cell phase constitutes a large percentage of the phase structuring the metallic structure (entire phase), and is a main phase of the Sm—Co based magnet. The main phase means a phase with a largest volume ratio out of the entire structure phase, and the volume ratio is preferably 50% or more, and is more preferably 70% or more.

The cell wall phase is a phase that exists, in a plate shape, in the grain boundary of the cell phase, and a width of the phase is about several nm to 10 nm. The platelet phase is a plate-shaped phase that exists so as to cross over a plurality of crystal grains, and exists perpendicular to the c-axis direction of the cell phase. For this reason, mutual platelet phases are observed in parallel in one domain. Each phase has a characteristic in terms of composition as well, in which the cell wall phase has a Cu concentration that is several times as large as that of the cell phase (main phase). The platelet phase has a concentration of the element M such as Zr, which is several times as large as that of the cell phase (main phase). When a concrete example is cited, in a sample in which the Cu concentration in the cell phase is about 3 atomic %, and the Zr concentration is about 1.5 atomic %, the Cu concentration in the cell wall phase is about 20 atomic %, and the Zr concentration in the platelet phase is about 4.5 atomic %.

The Sm—Co based magnet of this embodiment may also include a crystal phase or an amorphous phase other than the main phase formed of the 2-17 phase (cell phase), the grain boundary phase formed of the 1-5 phase or the like (cell wall phase), and the platelet phase. As another phase, there can be thought of an M-rich phase in which a concentration of the element M is higher than that of the cell phase, a compound phase whose main constituent is the element R and Fe, or the like, and it is preferable that an amount of the phase is almost an amount of an impurity phase. It is preferable that, practically, the metallic structure that forms the permanent magnet of the embodiment is formed of the cell phase, the cell wall phase and the platelet phase.

The composition of the permanent magnet of this embodiment can be measured by ICP (Inductively Coupled Plasma) emission spectrometry. The volume ratios of respective structure phases are determined comprehensively by using observation with an electron microscope or optical microscope and X-ray diffraction or the like together, and can be obtained by an area analysis method with a transmission electron microscope picture photographing a cross section (hard axis plane) of the permanent magnet. As the cross section of the permanent magnet, a cross section of a substantially center portion of a face having the maximum area in surfaces of a product is set to be used.

A magnetic domain wall energy of the 1-5 phase (cell wall phase) precipitated into the grain boundary of the 2-17 phase (cell phase) is larger than a magnetic domain wall energy of the 2-17 phase, and a difference between the magnetic domain wall energies becomes a barrier against magnetic domain wall displacement. It is conceivable that, in the Sm₂Co₁₇ type magnet, the 1-5 phase or the like having the large magnetic domain wall energy works as a pinning site, and thus the coercive force of magnetic domain wall pinning type is exerted. It can be considered that the difference between the magnetic domain wall energies is generated mainly by a concentration difference of Cu. If a Cu concentration in the cell wall phase is higher than a Cu concentration in the cell phase, it is conceivable that coercive force is exerted. For this reason, the cell wall phase preferably has a Cu concentration which is 1.2 times or more a Cu concentration in the cell phase. Accordingly, it is possible to make the cell wall phase sufficiently function as a pinning site of magnetic domain wall, which enables to obtain sufficient coercive force.

As a typical example of the cell wall phase (grain boundary phase) that exists in the grain boundary of the cell phase, the aforementioned 1-5 phase can be cited, but, the example is not necessarily limited to this. When the cell wall phase has the Cu concentration which is 1.2 times or more the Cu concentration in the cell phase, it is possible to make the cell wall phase sufficiently function as the pinning site of magnetic domain wall, and accordingly, it becomes possible to obtain high coercive force. Therefore, the cell wall phase is only required to be a Cu-rich phase as described above. As the cell wall phase other than the 1-5 phase, there can be cited the 1-7 phase being the high-temperature phase (structure before phase separation), a precursor phase of the 1-5 phase generated at an early stage of the phase separation of the 1-7 phase, and the like.

Cu is an essential element for making the Sm—Co based magnet exert high coercive force. Cu is enriched in the cell wall phase generated through aging treatment and the like. Accordingly, it is conceivable that since the cell wall phase works as the pinning site of magnetic domain wall, the coercive force is exerted. The Sm—Co based magnet is demanded to increase not only magnetization and coercive force but also (BH)ₘₐₓ. As described above, as the factors for determining the value of (BH)ₘₐₓ of the permanent magnet, there can be cited the squareness of hysteresis loop, in addition to the residual magnetization and the coercive force. Even if a magnet has large residual magnetization, when the squareness is poor, the value of (BH)ₘₐₓ becomes smaller than the theoretical value expected from the magnitude of the residual magnetization.

In order to increase magnetization of the Sm—Co based magnet, it is effective to replace a part of Co with Fe and to increase the Fe concentration. Accordingly, in the Sm—Co based magnet of the embodiment, the content of Fe is set to fall within a range of more than 30 atomic % and equal to or less than 45 atomic % (0.3<p≦0.45) of the total amount of the elements (Fe, Co, Cu, M) other than the element R. However, in a composition region having a high Fe concentration, the squareness of hysteresis loop of the Sm—Co based magnet tends to deteriorate. Such deterioration of squareness becomes a main cause to decrease the value of (BH)ₘₐₓ of the Sm—Co based magnet.

As a result of conducting earnest studies on a cause of deteriorating the aforementioned squareness, the present inventors found out that a variation in Cu concentration becomes easily generated in the cell wall phases in the composition region with high Fe concentration, resulting in that there are generated a cell wall phase having a large magnetic domain wall pinning potential and a cell wall phase having a small pinning potential. As described above, the magnetic domain wall energy of the cell wall phase changes depending on the Cu concentration, so that mutual cell wall phases with largely different Cu concentrations also have different magnitudes of domain wall pinning potentials.

When the magnetic domain wall pinning potential is different depending on the cell wall phase, there exist a region in which a magnetic domain wall displacement easily occurs and a region in which the magnetic domain wall displacement is difficult to occur. For this reason, the magnetic domain wall displacement when applying an external magnetic field occurs in stages from a cell phase surrounded by a cell wall phase with low Cu concentration toward a cell phase surrounded by a cell wall phase with high Cu concentration. Therefore, it is conceivable that in the Sm—Co based magnet having a composition with high Fe concentration, the squareness of hysteresis loop deteriorates. In order to improve the squareness that is influenced by a distribution of Cu concentration in the cell wall phase as above, it is effective to uniformize a spatial distribution of Cu concentration in the cell wall phase.

Accordingly, in the Sm—Co based magnet of this embodiment, the spatial distribution of Cu concentration in the cell wall phase (grain boundary phase) is set to 5 or less in standard deviation. By applying the cell wall phase having such spatial distribution of Cu concentration, it becomes possible to improve the squareness of hysteresis loop of the Sm—Co based magnet having high Fe concentration. Specifically, by improving the squareness of hysteresis loop of the Sm—Co based magnet while maintaining high magnetization given to the Sm—Co based magnet based on the high Fe concentration and high coercive force of the Sm—Co based magnet based on the phase separation structure, the difference in Cu concentration between the cell phase and the cell wall phase and the like, it is possible to improve the value of (_{BH})ₘₐₓ of the Sm—Co based magnet. Therefore, it becomes possible to provide high-performance Sm—Co based magnet.

Here, as an index representing the squareness, a squareness ratio is defined as follows, as a matter of convenience. Specifically, the squareness ratio is set to indicate a ratio of actual measured value of (BH)ₘₐₓ to a theoretical value of (BH)ₘₐₓ represented by an expression (2). The theoretical value of (BH)ₘₐₓ is set to indicate a value calculated, through an expression (3), from a value of measured residual magnetization (Br).

Squareness ratio=actual measured value of (BH)ₘₐₓ/theoretical value of (BHₘₐₓ×100(%) (2)

Theoretical value of (BH)ₘₐₓ=Br²/16π×10⁴ (3)

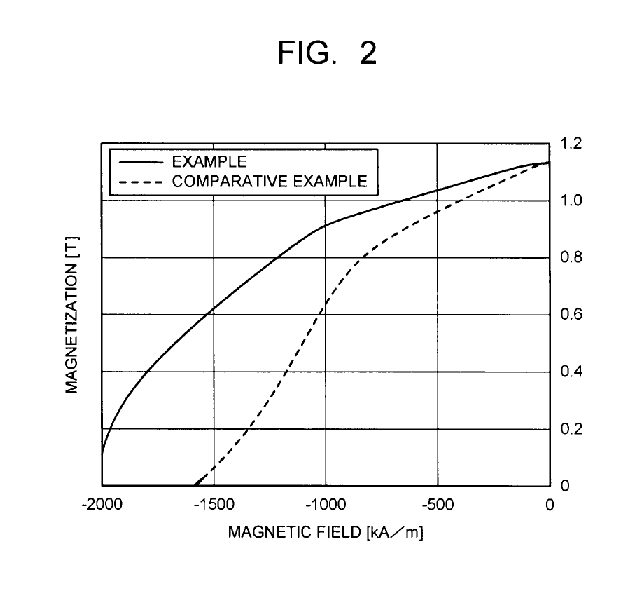

FIG. 2 is a diagram illustrating an example of magnetization curve of the Sm—Co based magnet of the embodiment by comparing it with a magnetization curve of a conventional Sm—Co based magnet. The Sm—Co based magnet of the embodiment and the conventional Sm—Co based magnet whose magnetization curves are represented in FIG. 2 have the same composition, and further, each of the magnets includes the metallic structure including the main phase (cell phase) formed of the 2-17 phase, the grain boundary phase (cell wall phase) and the platelet phase. However, although the spatial distribution of Cu concentration in the grain boundary phase of the Sm—Co based magnet of the embodiment is 5 or less in standard deviation, the spatial distribution of Cu concentration in the grain boundary phase of the conventional Sm—Co based magnet exceeds 5 in standard deviation.

As is apparent from FIG. 2, it can be understood that the Sm—Co based magnet of the embodiment has a good squareness of hysteresis loop. Concretely, the squareness ratio indicating the squareness of the Sm—Co based magnet is preferably 85% or more. The squareness ratio is a value represented by the aforementioned expression (2). By setting the squareness ratio of the Sm—Co based magnet to 85% or more, it is possible to improve the value of (BH)ₘₐₓ of the Sm—Co based magnet with good repeatability.

The spatial distribution of Cu concentration in the cell wall phase (grain boundary phase) changes depending on conditions of heat treatment such as solution treatment and aging treatment. In order to uniformize the spatial distribution of Cu concentration in the cell wall phase, it is effective to control a treatment temperature and a treatment time of the solution treatment, as will be described later. Regarding the aging treatment, it is effective to conduct preliminary aging treatment, before the present aging treatment, at a temperature lower than a temperature of the present aging treatment. Further, it is effective to strictly control the treatment temperature and the treatment time during the preliminary aging treatment and the present aging treatment, and a cooling rate after the treatment and the like.

Further, the squareness of hysteresis loop of the Sm—Co based magnet is also influence by a ratio (β/α) of an M concentration (β) in the platelet phase to an M concentration (α) in the grain boundary phase. Specifically, when the ratio (β/α) of M concentrations in the grain boundary phase and the platelet phase is too high, this means that the diffusion of element M typified by Zr does not proceed sufficiently. In such a case, not only the composition uniformity of the element M but also the composition uniformity of Cu becomes easily reduced.

For this reason, in order to improve the uniformity of the spatial distribution of Cu concentration, the ratio (β/α) of M concentrations in the grain boundary phase and the platelet phase is preferably set to less than 3. When the ratio (β/α) of M concentrations in the grain boundary phase and the platelet phase becomes 1 or less, the M concentration in the grain boundary phase becomes conversely higher than the M concentration in the platelet phase which originally has high M concentration, resulting in that the platelet phase does not function as a diffusion path. For this reason, the ratio (β/α) of M concentrations in the grain boundary phase and the platelet phase is preferably over 1.

The concentration of element in each structure phase described above is measured by an energy dispersive X-ray analysis with a transmission electron microscope. A transmission electron microscope image and a concrete measuring method in the energy dispersive X-ray analysis will be described hereinbelow. First, a sintered body or alloy after being subjected to aging treatment and in a demagnetization state, is cut in parallel with an easy magnetization axis to be a plate-shaped sample. At this time, the sample is taken from a position at 1 mm or less from a surface of the sintered body or alloy. Thereafter, the sample is processed into a thin plate by FIB (focused ion beam), to thereby obtain a sample for observation for transmission electron microscope. The measurement is conducted using the transmission electron microscope at an acceleration voltage of 200 kV and a magnification of ×100000, and adjustment is made so that a cell-shaped structure can be observed clearly. In the energy dispersive X-ray analysis, there is conducted analysis of the concentration of element in each structure phase, in the field of view.

The spatial distribution of Cu concentration in the grain boundary phase is measured in the following manner. First, analysis of Cu concentration (atomic %) in a cell wall phase portion is conducted. At this time, a center of a thickness of the cell wall phase is selected as a measurement point, and the measurement is performed on 10 points or more. Note that the respective measurement points are selected so that they are separated from each other by 150 nm or more. From the measurement data, a standard deviation of Cu concentration (σ) is calculated.

The ratio (β/α) of the M concentration (β) in the platelet phase to the M concentration (α) in the grain boundary phase is measured in the following manner. First, analysis of M concentration (atomic %) in the cell wall phase portion is conducted. At this time, a center of a thickness of the cell wall phase is selected as a measurement point, and the measurement is performed on 10 points or more. The measurement points are selected so that they are separated from each other by 150 nm or more. Analysis of M concentration (atomic %) in a platelet phase portion is conducted. A center of a thickness of the platelet phase is selected as a measurement point, and the measurement is performed on 10 or more of platelet phases observed in parallel. From each piece of measurement data regarding the cell wall phase and the platelet phase, average values of the M concentrations are calculated, these average values are respectively set to the M concentration (α) in the grain boundary phase and the M concentration (β) in the platelet phase, and a ratio (β/α) between these concentrations is calculated.

The permanent magnet of this embodiment is manufactured in the following manner, for example. First, an alloy powder containing a predetermined amount of element is prepared. The alloy powder is prepared by making an alloy thin band in a flake shape by a strip casting method, for example, and pulverizing this thin band. In the strip casting method, it is preferable to tilt-pour an alloy molten metal into a chill roll rotating at a peripheral speed of 0.1 to 20 m/sec, to thereby obtain a thin band continuously solidified with a thickness of 1 mm or less. When the circumferential speed of the chill roll is lower than 0.1 m/sec, dispersion of the composition can easily occur in the thin band, and when the circumferential speed is over 20 m/sec, the crystal grains are refined to the size of a single magnetic domain or smaller, and favorable magnetic characteristics cannot be obtained. The circumferential speed of the chill roll is more preferably in a range of 0.3 to 15 m/sec, and is further preferably in a range of 0.5 to 12 m/sec.

The alloy powder may also be prepared by pulverizing an alloy ingot obtained by casting molten metal made by an arc melting method or high-frequency melting method. Other methods for preparing the alloy powder include mechanical alloying method, mechanical grinding method, gas atomizing method, reduction diffusion method, and the like, and an alloy powder prepared by these methods can also be used. The alloy powder obtained in this manner or the alloy before being pulverized may be subjected to heat treatment as necessary to homogenize it. Pulverization of the flake or the ingot is performed using a jet mill, ball mill, or the like. To prevent oxidization of the alloy powder, it is preferable that the pulverization is performed in an inert gas atmosphere or in an organic solvent.

Next, the alloy powder is filled in a metal mold placed in an electromagnet, and pressure forming is performed while applying the magnetic field, thereby making a pressed powder body in which the crystal axis is oriented. The pressed powder body is sintered at a temperature of 1100 to 1300° C. for 0.5 to 15 hours, thereby obtaining a fine sintered body. If a sintering temperature is less than 1100° C., the density of the sintered body becomes insufficient. If the sintering temperature exceeds 1300° C., the rare earth element such as Sm evaporates and favorable magnetic characteristics cannot be obtained. The sintering temperature is more preferably set to be in a range of 1150 to 1250° C., and is further preferably set to be in a range of 1180 to 1230° C.

If a sintering time is less than 0.5 hours, the density of the sintered body may become uneven. On the other hand, if the sintering time exceeds 15 hours, the rare earth element such as Sm evaporates and favorable magnetic characteristics cannot be obtained. The sintering time is more preferably set to be in a range of 1 to 10 hours, and is further preferably set to be in a range of 1 to 4 hours. It is preferable to perform sintering of the pressed powder body in a vacuum or in an inert atmosphere such as argon gas in order to prevent oxidation.

Solution treatment and aging treatment are performed on the obtained sintered body to control the crystal structure. It is preferable that in the solution treatment, the sintered body is heat-treated at a temperature in a range of 1110 to 1200° C. for 0.5 to 24 hours in order to obtain the 1-7 phase being a precursor of a phase separation structure. At a temperature less than 1110° C. and a temperature over 1200° C., a ratio of the 1-7 phase in a sample after the solution treatment is small, and favorable magnetic characteristics cannot be obtained. Further, there is a possibility that the concentration distribution of each element in the 1-7 phase cannot be sufficiently uniformized. A solution treatment temperature is more preferably in a range of 1120 to 1180° C., and is further preferably in a range of 1120° C. to 1170° C.

If a solution treatment time is less than 0.5 hours, the structure phase easily becomes uneven, and further, there is a possibility that the concentration distribution of each element in the 1-7 phase cannot be sufficiently uniformized. If the solution treatment is performed for over 24 hours, the rare earth element such as Sm in the sintered body evaporates and so on, leading to a possibility that favorable magnetic characteristics cannot be obtained. The solution treatment time is more preferably set to fall within a range of 1 to 12 hours, and is further preferably set to fall within a range of 1 to 8 hours. It is preferable that the solution treatment is performed in a vacuum or an inert atmosphere such as argon gas in order to prevent oxidation.

Next, the aging treatment is performed on the sintered body after being subjected to the solution treatment. The aging treatment is treatment for controlling the crystal structure and increasing coercive force of the magnet. In order to uniformize the spatial distribution of Cu concentration in the grain boundary phase, it is preferable to conduct, before the present aging treatment (second aging treatment), preliminary aging treatment (first aging treatment) at a temperature lower than that of the present aging treatment. In the first aging treatment, it is preferable that the sintered body is retained at a temperature of 500 to 900° C. for 0.5 to 10 hours, and then is slowly cooled to a temperature of 20 to 450° C. at a cooling rate of 0.1 to 5° C./minute. By conducting such first aging treatment, it is possible to uniformize the spatial distribution of Cu concentration in the grain boundary phase. The ratio (β/α) of M concentrations in the grain boundary phase and the platelet phase is also controlled to fall within a favorable range.

In the second aging treatment, it is preferable that the sintered body is retained at a temperature of 700 to 900° C. for 10 to 100 hours, and thereafter, it is slowly cooled to a temperature of 20 to 600° C. at a cooling rate of 0.1 to 5° C./minute, and subsequently cooled to a room temperature. By conducting such second aging treatment, it becomes possible to improve coercive force of the Sm—Co based magnet having the phase separation structure. A treatment temperature T2 in the second aging treatment is preferably set higher than a treatment temperature T1 in the first aging treatment (T2>T1), which enables to uniformize the spatial distribution of Cu concentration in the grain boundary phase. It is preferable that the aging treatment is performed in a vacuum or an inert gas atmosphere such as argon gas in order to prevent oxidation.

When a first aging treatment temperature is less than 500° C. or over 900° C., the coercive force may decrease and the squareness may deteriorate. The first aging treatment temperature is more preferably 600 to 850° C., and is further preferably 700 to 850° C. When a first aging treatment time is less than 0.5 hours, the coercive force may decrease and the squareness may deteriorate. When the first aging treatment time exceeds 10 hours, the productivity decreases and the cost increases. The first aging treatment time is more preferably 1 to 5 hours.

When the cooling rate after the first aging heat treatment is less than 0.1° C./minute, the productivity decreases and the cost increases. When the cooling rate after the first aging heat treatment exceeds 5° C./minute, the squareness may deteriorate. The cooling rate after the first aging heat treatment is more preferably set to fall within a range of 0.5 to 4° C./minute, and is further preferably set to fall within a range of 1 to 3° C./minute.

When a second aging treatment temperature is less than 700° C. or over 900° C., there is a possibility that a homogenous mixed structure of the cell phase and the cell wall phase cannot be obtained, and magnetic characteristics of the permanent magnet decrease. The aging treatment temperature is more preferably 750 to 880° C., and is further preferably 780 to 850° C. If the second aging treatment time is less than 10 hours, the precipitation of cell wall phase from the 1-7 phase may not be sufficiently completed. On the other hand, if the retention time exceeds 100 hours, there is a possibility that the volume fraction of the cell phase decreases due to the increase in thickness of the cell wall phase, and favorable magnetic characteristics cannot be obtained since the crystal grain becomes coarse. The second aging treatment time is more preferably 10 to 90 hours, and is further preferably 20 to 80 hours.

When the cooling rate after the second aging heat treatment is less than 0.1° C./minute, the productivity decreases and the cost increases. When the cooling rate after the second aging heat treatment exceeds 5° C./minute, there is a possibility that a homogenous mixed structure of the cell phase and the cell wall phase cannot be obtained, and magnetic characteristics of the permanent magnet decrease. The cooling rate after the second aging heat treatment is more preferably set to fall within a range of 0.3 to 4° C./minute, and is further preferably set to fall within a range of 0.5 to 3° C./minute.

The permanent magnet of this embodiment can be used for various motors or generators. Further, the permanent magnet can also be used as a stationary magnet or a variable magnet in a variable magnetic flux motor or a variable magnetic flux generator. By using the permanent magnet of this embodiment, various motors or generators are structured. When the permanent magnet of this embodiment is applied to the variable magnetic flux motor, techniques well-known to the public can be applied to the structure and the drive system of the variable magnetic flux motor.

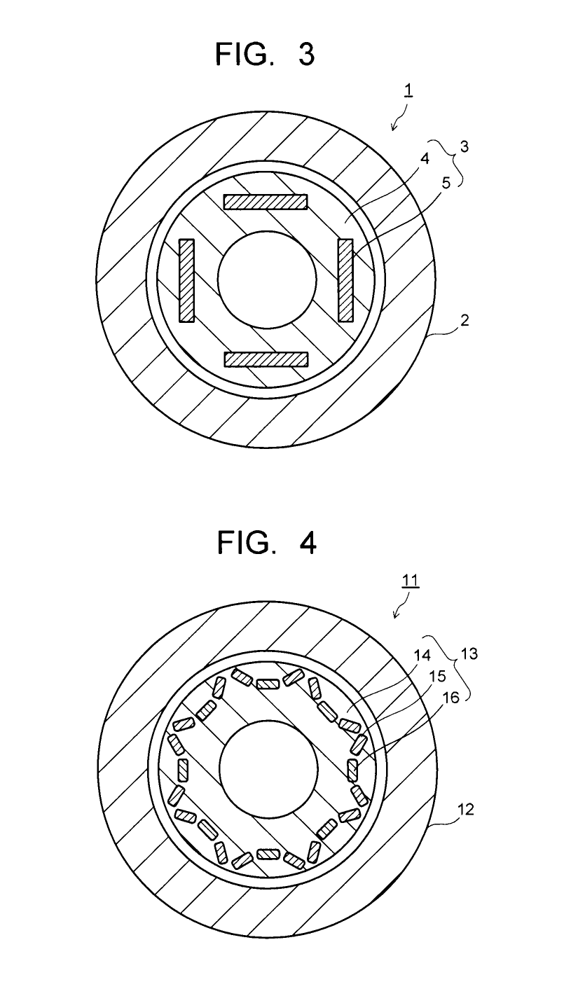

Next, a motor and a generator of the embodiment will be described with reference to the drawings. FIG. 3 illustrates a permanent magnet motor according to the embodiment. In a permanent magnet motor 1 illustrated in FIG. 3, a rotor 3 is disposed in a stator 2. In an iron core 4 in the rotor 3, there is disposed a permanent magnet 5 of the embodiment. Based on the characteristics of the permanent magnet of the embodiment and the like, it is possible to achieve high efficiency, size reduction, cost reduction and the like of the permanent magnet motor 1.

FIG. 4 illustrates a variable magnetic flux motor according to the embodiment. In a variable magnetic flux motor 11 illustrated in FIG. 4, a rotor 13 is disposed in a stator 12. In an iron core 14 in the rotor 13, there are disposed the permanent magnets of the embodiment as a stationary magnet 15 and a variable magnet 16. It is possible to change the magnetic flux density (magnetic flux amount) of the variable magnet 16. The variable magnet 16 has a magnetization direction orthogonal to a Q-axis direction, and hence is not affected by Q-axis current and can be magnetized by D-axis current. In the rotor 13, a magnetized winding (not illustrated) is provided. It is structured that application of current from a magnetization circuit to this magnetized winding causes the magnetic field thereof to directly act on the variable magnet 16.

According to the permanent magnet of the embodiment, by changing various conditions of the aforementioned manufacturing method, it is possible to obtain the stationary magnet 15 with coercive force exceeding 500 kA/m and the variable magnet 16 with coercive force of equal to or less than 500 kA/m, for example. Note that in the variable magnetic flux motor 11 illustrated in FIG. 4, although the permanent magnet of the embodiment can be used for both of the stationary magnet 15 and the variable magnet 16, the permanent magnet of the embodiment may be used for either one of the magnets. The variable magnetic flux motor 11, which can output a large torque by a small device size, is suitable for a motor for a hybrid vehicle, an electric vehicle or the like in which high power and downsizing of a motor is required.

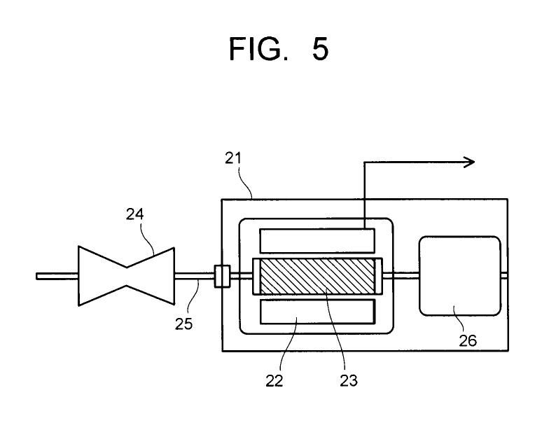

FIG. 5 illustrates a generator according to the embodiment. A generator 21 illustrated in FIG. 5 includes a stator 22 using the permanent magnet of the embodiment. A rotor 23 disposed inside the stator 22 is connected to a turbine 24 provided on one end of the generator 21 via a shaft 25. The turbine 24 rotates by fluid supplied from the outside, for example. Note that, instead of using the turbine 24 rotated by fluid, it is also possible to rotate the shaft 25 by transmitting dynamic rotation such as regenerated energy of a vehicle. For the stator 22 and the rotor 23, various publicly-known structures may be employed.

The shaft 25 is in contact with a commutator (not illustrated) disposed on the other side of the turbine 24 with respect to the rotor 23, and electromotive force generated by rotation of the rotor 23 is increased to system voltage via an isolated phase bus and a main transformer (not illustrated) and transmitted as output of the generator 21. As the generator 21, either of a normal generator and a variable magnetic flux generator can be used. Note that in the rotor 23, charge by static electricity from the turbine 24 and charge by shaft current accompanying power generation occur. Accordingly, the generator 21 has a brush 26 for discharging the charge on the rotor 23.

Next, examples and evaluation results thereof will be described.

### EXAMPLE 1

Respective materials were weighed to prepare a composition represented in Table 1, and then arc melted in an Ar gas atmosphere to make an alloy ingot. The alloy ingot was coarsely grinded in a mortar, and then pulverized in a jet mill, thereby preparing an alloy powder having an average grain diameter of 5 μm. The alloy powder was pressed under a pressing pressure of 1 t in a magnetic field of 1.5 T, thereby making a pressed powder body. The pressed powder body was sintered by being retained in an Ar atmosphere at 1200° C. for 3 hours, and was subsequently subjected to solution treatment at 1170° C. for 3 hours.

Next, the sintered body after solution treating was subjected to heat treatment, as first aging treatment, under the condition of 780° C.×3 hours, and was then slowly cooled to 200° C. at a cooling rate of 1° C./minute. Subsequently, the resultant was subjected to heat treatment, as second aging treatment, under the condition of 850° C.×10 hours, and thereafter, it was slowly cooled to 300° C. at a cooling rate of 1° C./minute, and further cooled to a room temperature. Both of the first and second aging treatments were conducted in the Ar atmosphere. The sintered magnet obtained in this manner was subjected to characteristic evaluation, which will be described later.

### EXAMPLE 2

Respective materials were weighed to have the same composition as that of the example 1, and then arc melted in an Ar gas atmosphere to make an alloy ingot. The alloy ingot was coarsely grinded in a mortar, and pulverized in a jet mill, thereby preparing an alloy powder having an average grain diameter of 4 μm. The alloy powder was pressed under a pressing pressure of 1 t in a magnetic field of 1.5 T, thereby making a pressed powder body. The pressed powder body was sintered by being retained in an Ar atmosphere at 1190° C. for 3 hours, and was subsequently subjected to solution treatment at 1150° C. for 5 hours.

Next, the sintered body after solution treating was subjected to heat treatment, as first aging treatment, under the condition of 730° C.×1.5 hours, and was then slowly cooled to 300° C. at a cooling rate of 1.5° C./minute. Subsequently, the resultant was subjected to heat treatment, as second aging treatment, under the condition of 850° C.×15 hours, and thereafter, it was slowly cooled to 500° C. at a cooling rate of 1.5° C./minute, and further cooled to a room temperature. Both of the first and second aging treatments were conducted in the Ar atmosphere. The obtained sintered magnet was subjected to characteristic evaluation, which will be described later.

### EXAMPLES 3 TO 6

Respective materials were weighed to prepare compositions represented in Table 1, and then arc melted in an Ar gas atmosphere to make alloy ingots. Each of the obtained alloy ingots was heat-treated in an Ar atmosphere at 1170° C. for 1 hour, and thereafter, the alloy ingot was coarsely grinded in a mortar, and further pulverized in a ball mill, thereby preparing an alloy powder having an average grain diameter of 4 μm. The alloy powder was pressed under a pressing pressure of 1 t in a magnetic field of 1.5 T, thereby making a pressed powder body. The pressed powder body was sintered by being retained in an Ar atmosphere at 1190° C. for 3 hours, and was subsequently subjected to solution treatment at 1150° C. for 3 hours.

Next, the sintered body after solution treating was subjected to heat treatment, as first aging treatment, under the condition of 720° C.×2 hours, and was then slowly cooled to 200° C. at a cooling rate of 1.5° C./minute. Subsequently, the resultant was subjected to heat treatment, as second aging treatment, under the condition of 810° C.×50 hours, and thereafter, it was slowly cooled to 400° C. at a cooling rate of 1° C./minute, and further cooled to a room temperature. Both of the first and second aging treatments were conducted in the Ar atmosphere. The sintered magnets obtained in this manner were subjected to characteristic evaluation, which will be described later.

### EXAMPLES 7 TO 9

Respective materials were weighed to prepare compositions represented in Table 1, and then arc melted in an Ar gas atmosphere to make alloy ingots. Each of the alloy ingots was charged into a nozzle made of quartz and melted by a high-frequency induction heating, and the molten metal was tilt-poured into a chill roll rotating at a peripheral speed of 0.6 m/sec, thereby making an alloy thin band which was solidified continuously. The alloy thin band was coarsely grinded, and then pulverized in a jet mill, thereby preparing an alloy powder having an average grain diameter of 4 μm. The alloy powder was pressed under a pressing pressure of 1 t in a magnetic field of 1.5 T, thereby making a pressed powder body. The pressed powder body was sintered by being retained in an Ar atmosphere at 1200° C. for 1 hour, and was subsequently subjected to solution treatment at 1170° C. for 10 hours.

Next, the sintered body after solution treating was subjected to heat treatment, as first aging treatment, under the condition of 750° C.×2 hours, and was then slowly cooled to 200° C. at a cooling rate of 1.5° C./minute. Subsequently, the resultant was subjected to heat treatment, as second aging treatment, under the condition of 850° C.×10 hours, and thereafter, it was slowly cooled to 600° C. at a cooling rate of 1° C./minute, and further cooled to a room temperature. Both of the first and second aging treatments were conducted in the Ar atmosphere. The sintered magnets obtained in this manner were subjected to characteristic evaluation, which will be described later.

### COMPARATIVE EXAMPLE 1

With the use of an alloy powder having the same composition as that of the example 1, a pressed powder body was made under the same condition as that of the example 1. The pressed powder body was sintered in an Ar atmosphere at 1220° C. for 3 hours, and was subsequently subjected to solution treatment at 1180° C. for 8 hours, thereby making a sintered body. Next, the sintered body after solution treating was subjected to heat treatment, as first aging treatment, under the condition of 780° C.×10 hours, and was then slowly cooled to 300° C. at a cooling rate of 7° C./minute. Subsequently, the resultant was subjected to heat treatment, as second aging treatment, under the condition of 850° C.×5 hours, and it was slowly cooled to 400° C. at a cooling rate of 0.5° C./minute, and further cooled to a room temperature. Both of the first and second aging treatments were conducted in the Ar atmosphere. The sintered magnet obtained in this manner was subjected to characteristic evaluation, which will be described later.

### COMPARATIVE EXAMPLE 2

With the use of an alloy powder having the same composition as that of the example 2, a pressed powder body was made under the same condition as that of the example 1. The pressed powder body was sintered in an Ar atmosphere at 1220° C. for 1 hour, and was subsequently subjected to solution treatment at 1210° C. for 8 hours, thereby making a sintered body. Next, the sintered body after solution treating was subjected to heat treatment, as first aging treatment, under the condition of 800° C.×8 hours, and was then slowly cooled to 200° C. at a cooling rate of 7° C./minute. Subsequently, the resultant was subjected to heat treatment, as second aging treatment, under the condition of 840° C.×3 hours, and it was slowly cooled to 400° C. at a cooling rate of 5° C./minute, and further cooled to a room temperature. Both of the first and second aging treatments were conducted in the Ar atmosphere. The sintered magnet obtained in this manner was subjected to characteristic evaluation, which will be described later.

### COMPARATIVE EXAMPLES 3 TO 9

With the use of alloy powders having compositions same as those of the examples 3 to 9, pressed powder bodys were made under conditions same as those of the examples 3 to 9. Each of the pressed powder bodys was sintered in an Ar atmosphere at 1220° C. for 3 hours, and was subsequently subjected to solution treatment at 1210° C. for 2 hours, thereby making a sintered body. Next, the sintered body after being subjected to the solution treatment was subjected to heat treatment, as first aging treatment, under the condition of 400° C.×7 hours, and was then slowly cooled to 200° C. at a cooling rate of 3° C./minute. Subsequently, the resultant was subjected to heat treatment, as second aging treatment, under the condition of 850° C.×5 hours, and thereafter, it was slowly cooled to 600° C. at a cooling rate of 5° C./minute, and further cooled to a room temperature. Both of the first and second aging treatments were conducted in the Ar atmosphere. The sintered magnets obtained in this manner were subjected to characteristic evaluation, which will be described later.

TABLE 1

| | Magnet composition (atomic ratio) |
|---|---|
| Example 1 | Sm(Fe_{0.32}Zr_{0.02}Cu_{0.05}Co_{0.61})_{7.8} |
| Example 2 | Sm(Fe_{0.32}Zr_{0.02}Cu_{0.05}Co_{0.61})_{7.8} |
| Example 3 | Sm(Fe_{0.33}Zr_{0.018}Cu_{0.05}Co_{0.602})_{7.5} |
| Example 4 | Sm(Fe_{0.31}(Zr_{0.7}Ti_{0.2}Hf_{0.1})_{0.03}Cu_{0.07}Co_{0.59})_{8.0} |
| Example 5 | Sm(Fe_{0.32}(Zr_{0.9}Ti_{0.1})_{0.04}Cu_{0.06}Co_{0.58})_{8.2} |
| Example 6 | (Sm_{0.8}Nd_{0.2})(Fe_{0.32}Zr_{0.03}Cu_{0.05}Co_{0.06})_{7.5} |
| Example 7 | (Sm_{0.8}Pr_{0.2})(Fe_{0.32}(Zr_{0.8}Ti_{0.2})_{0.035}Cu_{0.06}Co_{0.585})_{7.7} |
| Example 8 | (Sm_{0.8}Ce_{0.2})(Fe_{0.31}Zr_{0.025}Cu_{0.06}Co_{0.605})_{8.0} |
| Example 9 | (Sm_{0.7}Y_{0.1}Nd_{0.2})(Fe_{0.32}Zr_{0.027}Cu_{0.06}Co_{0.593})_{7.7} |
| Comparative | Sm(Fe_{0.32}Zr_{0.02}Cu_{0.05}Co_{0.61})_{7.8} |
| Example 1 | |
| Comparative | Sm(Fe_{0.32}Zr_{0.02}Cu_{0.05}Co_{0.61})_{7.8} |
| Example 2 | |
| Comparative | Sm(Fe_{0.33}Zr_{0.018}Cu_{0.05}Co_{0.602})_{7.5} |
| Example 3 | |
| Comparative | Sm(Fe_{0.31}(Zr_{0.7}Ti_{0.2}Hf_{0.1})_{0.03}Cu_{0.07}Co_{0.59})_{8.0} |
| Example 4 | |
| Comparative | Sm(Fe_{0.32}(Zr_{0.9}Ti_{0.1})_{0.04}Cu_{0.06}Co_{0.58})_{8.2} |
| Example 5 | |
| Comparative | (Sm_{0.8}Nd_{0.2})(Fe_{0.32}Zr_{0.03}Cu_{0.05}Co_{0.60})_{7.5} |
| Example 6 | |
| Comparative | (Sm_{0.8}Pr_{0.2})(Fe_{0.32}(Zr_{0.8}Ti_{0.2})_{0.035}Cu_{0.06}Co_{0.585})_{7.7} |
| Example 7 | |
| Comparative | (Sm_{0.8}Ce_{0.2})(Fe_{0.31}Zr_{0.025}Cu_{0.06}Co_{0.605})_{8.0} |
| Example 8 | |
| Comparative | (Sm_{0.7}Y_{0.1}Nd_{0.2})(Fe_{0.32}Zr_{0.027}Cu_{0.06}Co_{0.593})_{7.7} |
| Example 9 | |

A metallic structure of each of the sintered magnets of the examples 1 to 9 and the comparative examples 1 to 9 was observed using TEM. As a result of this, it was confirmed that each metallic structure has the 2-17 phase (cell phase), the grain boundary phase (cell wall phase) and the platelet phase. The grain boundary phase was confirmed to have a Cu concentration which is 1.2 times or more a Cu concentration in the 2-17 phase. Based on the aforementioned methods, the standard deviation of the spatial distribution of Cu concentration in the grain boundary phase, and the ratio of M concentrations in the grain boundary phase and the platelet phase (β/α) were determined. Results thereof are represented in Table 2. Next, magnetic characteristics of each of the sintered magnets were evaluated using a BH tracer, and residual magnetization, coercive force and (BH)ₘₐₓ were measured. Further, from the measured residual magnetization and the actual measured value of (BH)ₘₐₓ, a squareness ratio was determined based on the aforementioned method. The squareness ratio of each example is represented in Table 2.

TABLE 2

| | Standard | Ratio of M | |
|---|---|---|---|
| | deviation σ | concentrations | |
| | of Cu | in grain boundary | Magnetic |
| | concentration | phase and | characteristic |
| | in grain | platelet phase | Squareness |
| | boundary phase | (α/β) | ratio (%) |
| Example 1 | 2.8 | 1.8 | 92 |
| Example 2 | 3.6 | 3.3 | 89 |
| Example 3 | 3.5 | 2.0 | 87 |
| Example 4 | 4.0 | 2.3 | 90 |
| Example 5 | 3.7 | 1.9 | 89 |
| Example 6 | 4.1 | 2.7 | 90 |
| Example 7 | 3.5 | 2.4 | 89 |
| Example 8 | 3.3 | 1.7 | 91 |
| Example 9 | 3.2 | 1.5 | 88 |
| Comparative | 7.5 | 2.3 | 79 |
| Example 1 | | | |
| Comparative | 6.7 | 3.4 | 81 |
| Example 2 | | | |
| Comparative | 8.0 | 3.2 | 78 |
| Example 3 | | | |
| Comparative | 7.6 | 4.0 | 76 |
| Example 4 | | | |
| Comparative | 7.3 | 3.1 | 79 |
| Example 5 | | | |
| Comparative | 6.9 | 3.0 | 80 |
| Example 6 | | | |
| Comparative | 8.3 | 3.3 | 80 |
| Example 7 | | | |
| Comparative | 7.2 | 2.9 | 81 |
| Example 8 | | | |
| Comparative | 6.5 | 3.2 | 82 |
| Example 9 | | | |

As is apparent from Table 2, it can be understood that each of the sintered magnets of the examples 1 to 9 has high squareness ratio. On the contrary, each of the permanent magnets of the comparative examples 1 to 9 cannot obtain sufficient squareness ratio due to the low standard deviation of the spatial distribution of Cu concentration in the grain boundary phase. The residual magnetization was 1.14 to 1.20 T in the examples 1 to 5 and the comparative examples 1 to 5, and was 1.16 to 1.23 T in the examples 6 to 9 and the comparative examples 6 to 9. The coercive force was 1100 to 2000 kA/m in the examples 1 to 5, 800 to 1500 kA/m in the examples 6 to 9, 800 to 2000 kA/m in the comparative examples 1 to 5, and 500 to 1500 kA/m in the comparative examples 6 to 9. The value of (BH)ₘₐₓ of each of the permanent magnets of the comparative examples 1 to 9 was confirmed to be smaller than a theoretical value expected from a magnitude of the residual magnetization.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A permanent magnet, comprising:
a composition represented by a composition formula:
R(FeₚM_{q}Cuᵣ(Co_{1-p-q-r})_{z}
where, R is at least one element selected from rare earth elements, M is at least one element selected from Ti, Zr and Hf, p is a number satisfying 0.3<p≦0.45 (atomic ratio), q is a number satisfying 0.01≦q≦0.05 (atomic ratio), r is a number satisfying 0.01≦r≦0.1 (atomic ratio), z is a number satisfying 5.6≦z≦9 (atomic ratio); and
a metallic structure including a Th₂Zn₁₇ crystal phase, a grain boundary phase and a platelet phase,
wherein a spatial distribution of Cu concentration in the grain boundary phase is 5 or less in standard deviation.

2. The permanent magnet according to claim 1,
wherein a ratio of a concentration of the element M in the platelet phase to a concentration of the element M in the grain boundary phase is in a range of more than 1 and less than 3.

3. The permanent magnet according to claim 2,
wherein a squareness ratio of the permanent magnet is 85% or more.

4. The permanent magnet according to claim 1,
wherein the grain boundary phase has a Cu concentration which is 1.2 times or more a Cu concentration in the Th₂Zn₁₇ crystal phase.

5. The permanent magnet according to claim 1,
wherein the grain boundary phase has a CaCu₅ crystal phase.

6. The permanent magnet according to claim 1,
wherein 50 atomic % or more of the element R is samarium.

7. The permanent magnet according to claim 1,
wherein 50 atomic % or more of the element M is zirconium.

8. The permanent magnet according to claim 1,
wherein 20 atomic % or less of Co is replaced with at least one element A selected from Ni, V, Cr, Mn, Al, Ga, Nb, Ta and W.

9. A motor comprising the permanent magnet according to claim 1.

10. A generator comprising the permanent magnet according to claim 1.
